(19) United States
(12) Patent Application Publication
(10) Pub. No.: US 2007/0016564 A1
(43) Pub. Date: Jan. 18, 2007

(54) Database search engine

(76) Inventor: Peilin Chou, Taipei (TW)

Correspondence Address: Genus Law Group (Lowe Hauptman & Berner), Suite 300, 1700 Diagonal Road, Alexandria, VA, 22314, US

(21) Appl. No.: 11/434,911

(22) Filed: May 17, 2006

(30) Foreign Application Priority Data
Jul. 12, 2005 (TW) 94124779

(51) Int. Cl. G06F 17/30

(52) U.S. Cl. 707/3

(57) ABSTRACT

A database search engine, comprising: a search condition collector to collect data designated by a user; a search condition generator to o convert said collected data into database search conditions in particular formats; a database search device to search in particular databases data files satisfying said search conditions; and a search result display device to generate a webpage description file comprising descriptions of a search condition collector and said search results; wherein said search condition collector comprises: a database search data identifying device to automatically identify and collect said user-designated data; and a search frame description file to be included in said webpage description file.

### FIELD OF THE INVENTION

The present invention relates to a database search engine, especially to a database search engine that searches database according to content of a selected area in a webpage.

### BACKGROUND OF THE INVENTION

The webpage search engine is a useful tool in the application of the internet. Users are allowed to use the webpage search engine to search in databases by simply keying in search conditions directly in the webpage. The search conditions are transmitted to the website of the search engine provider, to enable the search engine to search in particular databases for data files that satisfy the search conditions. The results are then transmitted to the user's computer and are displayed in the display device of the user computer.

Currently there are many popular search engine service providers. They provide a search engine interface in their webpages, allowing users to key in search conditions in the search engine interface. The input search conditions are received by the search engine website to initialize searches. In addition, content providers also provide a search interface in their webpages, allowing users to search useful data in the database that contains their contents. In many enterprises, their websites or portals would also provide similar tools to enable online searches by authorized users in related databases.

In, these conventional search engine websites, ordinary websites or portals, a search frame will be provided in the related webpages to accept user's search conditions. To initialize a search operation, the user needs to key in search conditions and click a search key. When the search key is clicked, the components of the search tool is activated, whereby the related instructions and search conditions are transmitted to the connected website to activate the search tools in the website to conduct searches according to related search conditions.

In the conventional webpage search tool, the search frame accepts a limited number of search conditions. For example, most search frames accept only up to about 25 characters as search conditions. If the search conditions have a length exceeding the limitation, the search is impossible. Some webpage search tools provide an interface that allows users to paste a paragraph or an article into the search frame as search conditions. This application, however, is complicated and not convenient.

It is thus necessary to provide a database search engine that is easy to use.

It is also necessary to provide a database search engine to allow user to search in databases without the need of inputting keywords or clipping-and-pasting paragraphs or articles.

It is also necessary to provide a database search engine, whereby users activate searches by simply selecting an area in the webpage being viewed.

### OBJECTIVES OF THE INVENTION

The objective of this invention is to provide a database search engine that is easy to use.

Another objective of this invention is to provide a database search engine to allow user to search in databases without the need of inputting keywords or clipping-and-pasting paragraphs or articles.

Another objective of this invention is to provide a database search engine, whereby users activate searches by simply selecting an area in the webpage being viewed.

### SUMMERY OF THE INVENTION

According to this invention, a database search engine is provided. The database search engine of this invention comprises:

a search condition collector to collect data for database search conditions designated by a user and to transmit the collected data to said database search engine to enable a search;

a search condition generator to accept said data collected by said search condition collector and to convert said collected data into database search conditions in particular formats;

a database search device to connect particular databases and to search in said databases data files satisfying said search conditions generated by said search condition generator; and

a search result display device to generate a webpage description file comprising descriptions of a search condition collector and representations of results of searches by said database search device and to send said webpage description file to a computer of said user for display;

wherein said search condition collector comprises: a database search data identifying device to automatically identify and collect said data for database search conditions designated by said user, when a “start” instruction is activated by said user; and a search frame description file to be included in said webpage description file and to generate an image of a search frame in webpage described by said webpage description file.

In an embodiment of this invention, the database search data identifying device identifies data included in the search frame as the user-designated database search data. In another embodiment of this invention, the content of a selected region in a webpage is used as said user-designated data for database search conditions. In a further embodiment of this invention, all data of a webpage are used as said user-designated data for database search conditions.

These and other objectives and objectives of this invention may be clearly understood from the detailed description by referring to the following drawings.

### BRIEF DESCRIPTION OF THE DRAWINGS

FIG. 1 shows the systematic diagram of the database search engine of this invention.

FIG. 2 illustrates a search frame used in the database search engine of this invention.

FIG. 3 shows the source list of a computer program that defines the search condition collector of the present invention.

FIG. 4 shows the flowchart of the application of the database search engine of this invention.

### DETAILED DESCRIPTION OF THE INVENTION

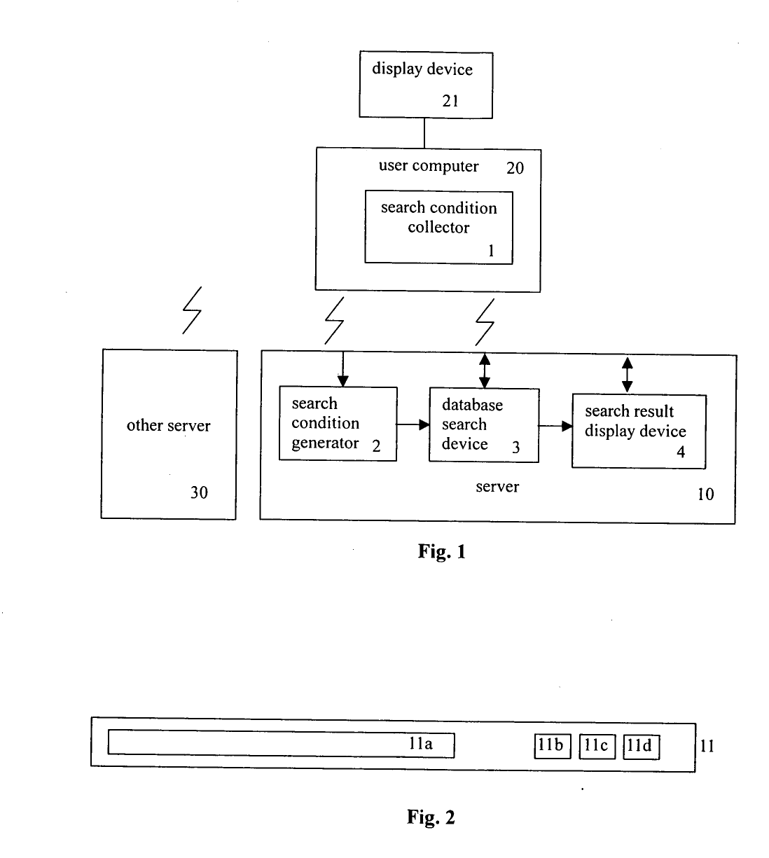

FIG. 1 shows the systematic diagram of the database search engine of this invention. As shown in this figure, the database search engine includes: a search condition collector 1, a search condition generator 2, a database search device 3 and a search result display device 4. The search condition collector 1 collects data for database search conditions input by a user and transmits the collected data to the database search engine to enable a search. The search condition generator 2 accepts the data for database search conditions collected by the search condition collector 1 and converts the collected data into database search conditions in particular formats. The database search device 3 connects particular databases and searches in the databases data files satisfying the search conditions generated by the search condition generator. The search result display device 4 generates a webpage description file comprising descriptions of a search condition collector 1 and representations of results of searches by said database search device and sends the webpage description file to the computer 20 of the user for display.

The search condition collector 1 comprises: a database search data identifying device 12 to automatically identify and collect the data for database search conditions designated by the user, when a “start” instruction is activated by the user; and a search frame description file 13 to be included in the webpage description file and to generate an image of a search frame in webpage described by the webpage description file.

A database search engine having the above-described structure may be installed in a server 10 that is remote to all users, except the search condition collector 1. The search condition collector 1 may be attached to a webpage description file and sent to the user computer 20 along with the webpage description file. As the webpage described by the webpage description file is displayed in the user computer 20, the search condition collector 1 may also be displayed in the display device 21 of the user computer 20. The search condition collector 1 may be displayed in the form of a search frame 11. It is possible to send the definition information of the search condition collector 1 from the server 10. It is also possible to send the definition information from another server 30 that provides other functions. The other server 30 may represent a search engine website, an information network or the server of an enterprise network. When the user computer 20 is in connection with server 30, the server 30 transmits a webpage description file to the user computer 20, so that the webpage of the webpage description file is displayed in the display device 21 of the user computer 20. In the webpage so generated, not only one or more information displaying regions are shown but also a plurality of function keys is shown. The search frame 11 then is displayed within the scope of the above-said webpage.

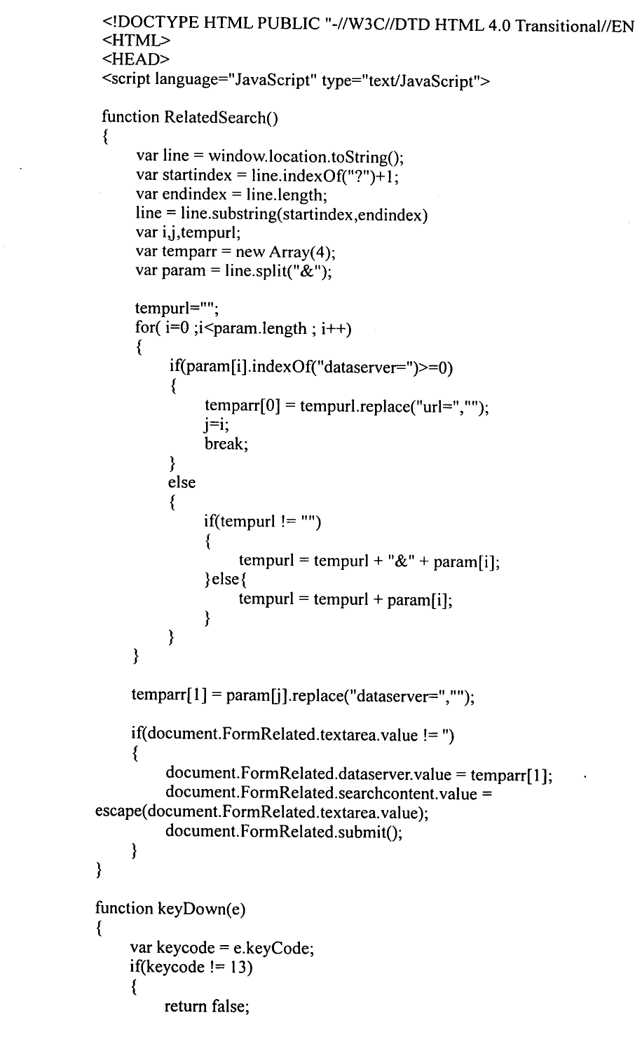

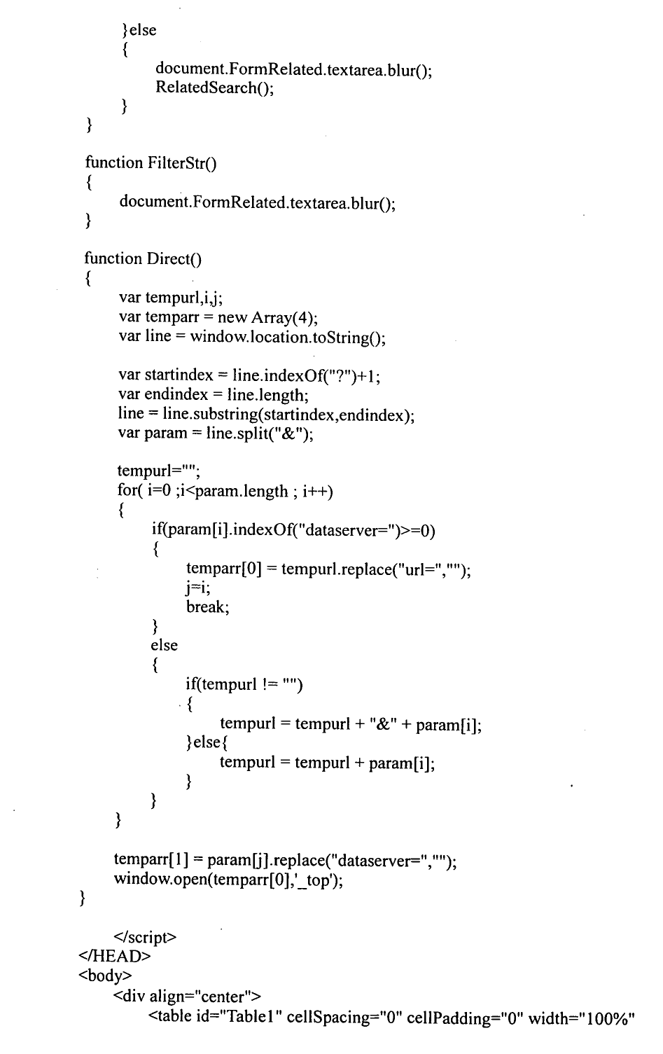

While in the application, the search frame 11 may include a data input zone 11a and several input keys 11b, 11c and 11d, as shown in FIG. 2. FIG. 2 illustrates a search frame used in one embodiment of the database search engine of this invention. As shown in this figure, the search frame in this embodiment includes a text input zone 11a, a text selection search key 11b, a general search key 11c and a website connection key 11d. Among them, the text input zone 11a accepts user's input of data, such as text etc., as bases of the search to be conducted. By clicking the text selection key 11b, the user may activate a search instruction. The database search data identifying device 12 of the search condition collector 11 allocates regions in the above-said webpage as they are selected by the user and sends all data contained in the selected regions, including text etc., along with the search instruction, to the search condition generator 2, when the text search key 11b is clicked. In general applications, the regions selected by the user may be the regions in the webpage, where the content being displayed is in reverse effects. Of course, it is possible to use other methods to show the user's selections. The general search key 11c may active a search instruction. When the user clicks this general search key 11c, the database search data identifying device 12 search condition collector 1 searches in the data input zone 11a data input by the user and sends all data in the data input zone 11a, along with the search instruction, to the search condition generator 2. The database search data identifying device 12 of the database search engine of this invention further provides a function to send all contents, or all text contents, of the webpage, along with the search instruction, to the search condition generator 2, when no data are available within the data input zone 11a, i.e., when data contained in the data input zone 11a consist an empty set. Of course, it is also possible to identify a paragraph or a section of sentences on which the cursor locates as the user-selected data. The content of the paragraph, always a paragraph of sentences representing the results of a previous search, and a search instruction is then sent to the search condition generator 2 to generate search conditions. By using the above designs, the user is allowed to select any text information as the user's search conditions.

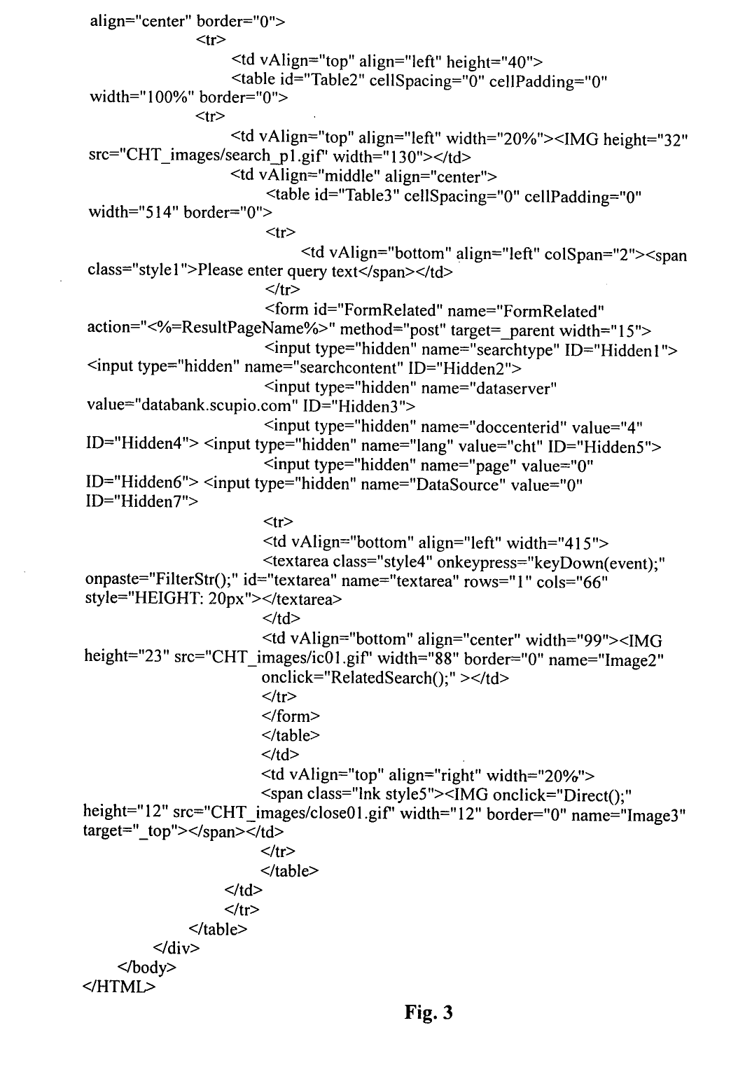

The search condition collector 1 may comprise a definition file 13 including definitions of the search frame 11. The search frame 11 may be defined by “Java Script” functions. The Java Script functions enable engineers to define webpage data grabbing instructions with a series of simple instructions, to collect data within selected regions of the webpage where the search frame is included or of a webpage where the search frame is not included. The data so collected are then sent to the search condition generator 2 of the database search engine. The selectable data may be those displayed within the data input zone 11a, all data displayed in one webpage or data displayed in the selected regions. As to the transmission of the collected data, it may be any commercially available methods, including the HTTP POST function. FIG. 3 shows the source list of a computer program that defines the search condition collector of the present invention. In this figure, the address of www.scupio.com represents the address of the server where the database search engine is installed. As shown in this figure, the search condition collector 1 of this invention may be defined by a short computer program. The computer program 13 may be attached to any webpage definition file and may be sent to the user computer along with the webpage definition file transmitted to internet users by service providers. After the user computer 20 receives the definition file, the search frame will be displayed in the display device 21 of the user computer 20, to accept user's search instructions and search conditions. As a result, the user needs not to download any additional execution file, program tool or other computer software from the website of the service provider, from the search engine website or any recording medium. The user may use the attached search frame in the webpage to conduct desired database searches.

In another embodiment of the database search engine of the present invention, the definition file 13 of the search condition collector 11 is provided by the database search engine independently. When the user computer 20 receives the definition file, it may display the search frame on the webpage then displayed. Although the search frame and the webpage are two separate webpages, it is possible to so arrange that two or more webpages are simultaneously displayed. In that case, the user won't feel any inconvenience in shifting among webpages. The search condition collector 1 is able to collect all data or data in selected regions in the webpage that is displayed simultaneously with the search frame and send the collected data to the database search engine. In the computer program of FIG. 3, this function has been provided.

When the search condition generator 2 receives the search data from the search condition collector 1, the data is analyzed and a series of definitions of search conditions is generated according results of the analysis. In the application of this invention, it is suggested that a “relativity search” mechanism is provided. In other words, the data collected by the search condition collector 1 are always a string of text, including several to several hundred characters or words. The “relativity search” mechanism analyzes content of the string of text to generate a description file to include a series of descriptions of the meanings of the string or the topic of the related search. The database search device 3 may thus use the descriptions to conduct the desired search.

U.S. patent Ser. No. 10/794,693 discloses a technology that automatically generates a series of search conditions according to the content of a string of characters. In summery, the search conditions are generated by analyzing the “terms” included in the string of characters, calculate number of duplicate of each term (“frequency”) and compose a string of terms and their respective frequency. The “weight” of each term is calculated according to a particular method to compose a series of terms and their respective weights. The search condition definition file is generated by connecting the terms and their weights by logical and. After normalization, terms with 0 weight and negative weights are identified. A search condition definition file is thus generated.

In the application of this prior art, terms that would appear in ordinary articles or in ordinary webpages are defined as 0 weight. These terms are collected and listed in the search condition generator 2 for further use. The search condition files generated according to this method are able to define the topic of the paragraph of sentences and may be used as search conditions to search desired articles. Other methods that are able to generate a description file to include a series of descriptions according to a paragraph of text may also be used in the present invention, as long as the description file may be used directly as search conditions for searching in databases. Of course, the present invention is not limited to the “relativity search” method. Other methods may also be used in this invention independently or in combination. Any methods that may automatically generate, according to a section of input text, a description file to include a series search conditions that may be used by the database search engine directly, may also be used in this invention.

In addition, data that the search condition collector 1 collects and the search condition generator 2 uses to generate search conditions are not limited to text data. Other data, such as symbols, numbers, formulas, chemical formulas, description of figures including dot matrix, vector or others, spectra, animations and other media data defined or described in any methods, may be applicable in this invention.

The search conditions generated by the search condition generator 2 may be obtained by the database search device 3. The database search device 3 uses the search conditions to search data files that satisfy the search conditions in particular databases. The database search device 3 compares the content of data files in the particular databases, or the content of their description files. The data files that have similarity values equal to or over a threshold value are selected as searched files. The files are defined by their address or their content. Since searching in a database according to particular search conditions is a matured technology and those skilled in the art may realize such or similar technologies using the known arts, detailed description thereof is thus omitted.

The search results generated by the database search device 3 are sent to the search result display device 4. The search results display device 4 picks up contents that are determined as representations of a predetermined number of data files. The search result display device 4 automatically generates a webpage definition to include the selected representations, attaches relative descriptions and sends the information so obtained to the user computer 20. The user computer 20 thus displays the search result information in its display device 21. In the embodiments of this invention, the webpage description file preferably further contains the definition file of a search condition collector. In that case, in the display device 21 of the user computer 20, a webpage including the search results, descriptions of the search results and a search frame is displayed. The user may use the search frame to conduct further searches, using the previous search results as references or search conditions. Of course, if no such search condition collector is attached, the user may use the search condition collector that is attached to the old webpage. This is because the search condition collector provides the function of grasping data from another webpage. The webpage generated by the search result display device 4 may be an independent webpage or a webpage to be displayed and included within the frame of the old webpage.

When the user selects a search result, the functional devices provided in the webpage connects the user computer to the address of the data file represented by the selected search result. The server (not shown) of the connected address picks up the content of the data file, sends the content to the user computer 20 and displays the content in the display device 21 of the user computer 20. In another embodiment of this invention, the content of the selected data file is displayed display page defined by the search result display device 4. As a result, the user may continue to use the displayed information to conduct further searches. Possible ways to use the displayed information include: The search result display device 4 picks up the related content and sends the content to within the frame of the old webpage. The search result display device 4 may also preserve the webpage that is displayed in the display device 21 of the user computer 20, so that the content obtained by the user computer 20 after it is connected is displayed in the frame of the preserved webpage. Of course, other method for displaying the search results and enabling the user to continue the search may also be used in this invention. These and other displaying technologies are known to those skilled in the art. Detailed descriptions thereof are thus omitted.

With the above-mentioned designs, the user may use the database search engine of this invention to conduct multiple-leveled searches freely and conveniently.

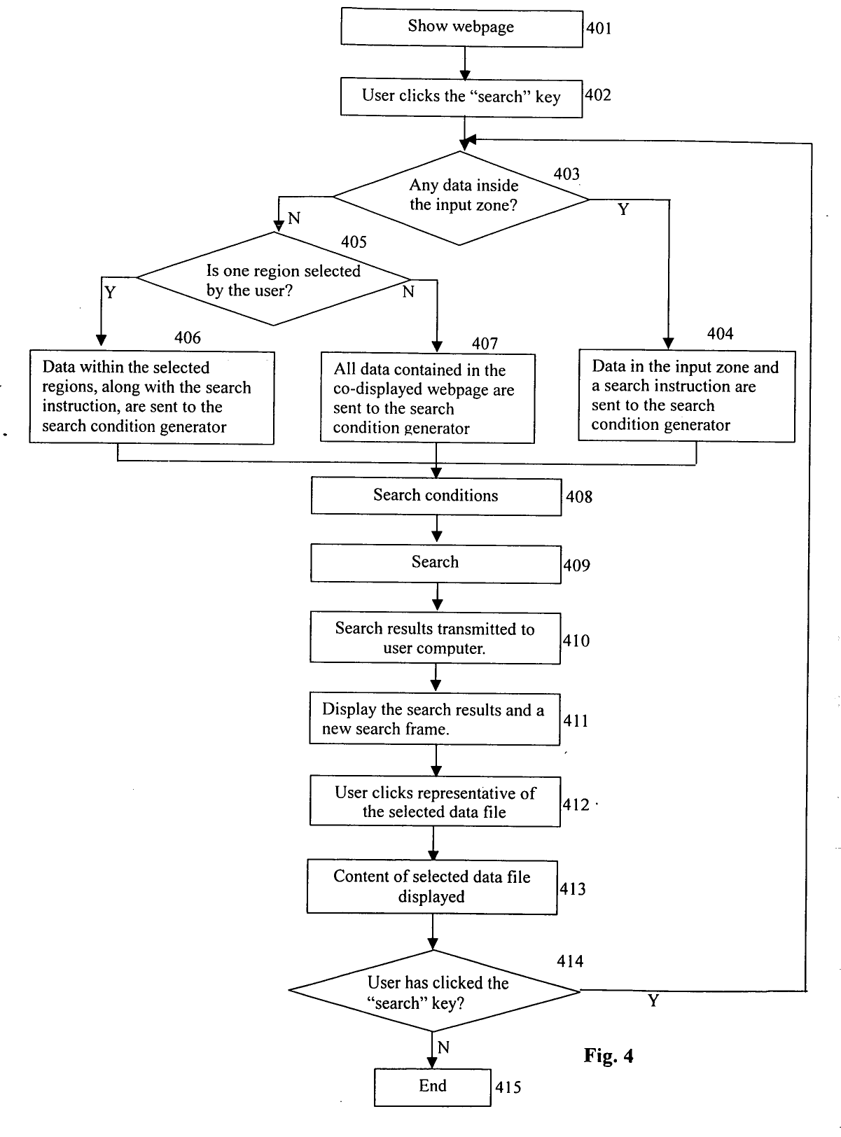

An example of searching in the internet with the database search engine of this invention will be given below. FIG. 4 shows the flowchart of the application of the database search engine of this invention. As shown in this figure, at 401 the user keys in the domain name or the IP address of a website. The webpage of the selected website is thus shown in the display device 21 of the user computer 20. The webpage as shown includes a search frame, as that shown in FIG. 2. At 402 the user clicks the “search” key 11c of the search frame 11. At 403 the search condition collector 1 determines whether data inside the input zone 11a of the search frame 1 consist an empty set. If no, the data inside the input zone 11 a, along with a search instruction, are sent to the search condition generator 2 at 404. Otherwise, at 405 the search condition collector 1 determines whether at least one region in the website being displayed simultaneously with the search frame 11 is selected by the user at. If yes, at 406 the data within the selected regions, along with the search instruction, are sent to the search condition generator 2. Otherwise, at 407 all data contained in the above-mentioned webpage are sent to the search condition generator 2. at 408 the search condition generator 2 analyzes the obtained data and automatically generates a series of search conditions. At 409 the database search device 3 searches in designated databases according to the search conditions so generated. At 410 the search result display device 4 automatically generates a webpage description and transmits the webpage description, along with the search results of the database search device 3 and, if applicable, the definition file of a new search frame, to the user computer 20. At 411 the display device 21 of the user computer 20 displays the search results and a new search frame. The search results are always a list of outlines representing respective data files. At 412 the user selects one of the listed data files by clicking at the outlines representing the selected data file, thereby the user computer 20 is connected to the server where the selected data file is stored. At 413 the server releases content of the data file and sends the content to the user computer 20, displayed in the display device 21. At 414 the search condition collector 1 determines whether the user has clicked the “search” key. If yes, the step returns to 403; otherwise the operation ends at 415.

The present invention provides a database search engine to allow the user to conduct searches in a plurality of databases without the need of inputting keywords or clipping-and-pasting articles of paragraphs. The user simply selects a paragraph or an article in the webpage that is currently displayed. By clicking at the search key in the search frame of this invention, the database search engine of this invention will automatically analyze the selected paragraph or article, generate search conditions and start to search in particular databases data files that satisfy the search conditions so generated. Multiple level searches without difficult are thus made possible.

As the present invention has been shown and described with reference to preferred embodiments thereof, those skilled in the art will recognize that the above and other changes may be made therein without departing from the spirit and scope of the invention. The scope of the present invention may only be interpreted and limited according to the following claims.

What is claimed is:

1. A database search engine, comprising:
a search condition collector to collect data for database search conditions designated by a user and to transmit the collected data to said database search engine to enable a search;
a search condition generator to accept said data collected by said search condition collector and to convert said collected data into database search conditions in particular formats;
a database search device to connect particular databases and to search in said databases data files satisfying said search conditions generated by said search condition generator; and
a search result display device to generate a webpage description file comprising descriptions of a search condition collector and representations of results of searches by said database search device and to send said webpage description file to a computer of said user for display;
wherein said search condition collector comprises: a database search data identifying device to automatically identify and collect said data for database search conditions designated by said user, when a “start” instruction is activated by said user; and a search frame description file to be included in said webpage description file and to generate an image of a search frame in webpage described by said webpage description file.

2. The database search engine according to claim 1, wherein said database search data identifying device identifies data included in said search frame as said user-designated data for database search condition.

3. The database search engine according to claim 1, wherein said database search data identifying device identifies data of a selected region in a webpage as said user-designated data for database search conditions.

4. The database search engine according to claim 1, wherein said database search data identifying device identifies all data of a webpage said user-designated data for database search conditions.

5. The database search engine according to claim 1, wherein said database search data identifying device identifies all data of a webpage said user-designated data for database search conditions, when no data in said webpage are in reverse effects.

6. The database search engine according to claim 1, wherein said search frame comprises a plurality of function key displaying zones.

7. The database search engine according to claim 1, wherein said description file for said search condition collector is generated by said database search engine, whereby a search frame representing said description file is displayed in a webpage currently displayed in said user computer.
